(19) United States
(12) Patent Application Publication
(10) Pub. No.: US 2024/0396398 A1
(43) Pub. Date: Nov. 28, 2024

(54) STATOR FOR ROTATING ELECTRIC MACHINE

(71) Applicant: DENSO CORPORATION, Kariya-city (JP)

(72) Inventor: MASATAKA YOSHIMURA, Kariya-city (JP)

(21) Appl. No.: 18/795,680

(22) Filed: Aug. 6, 2024

Related U.S. Application Data
(63) Continuation of application No. PCT/JP2022/031098, filed on Aug. 17, 2022.

(30) Foreign Application Priority Data
Feb. 8, 2022 (JP) 2022-018173

(51) Int. Cl. H02K 3/50

(52) U.S. Cl. CPC H02K 3/50; H02K 2203/06; H02K 2203/09

(57) ABSTRACT

A stator is applicable to a rotary electric machine that includes a terminal block. The stator has a stator coil. The stator includes a lead wire drawn out from the stator coil, a bus bar, a first terminal electrically connecting the lead wire with the bus bar, and a second terminal electrically connected to the bus bar and fixed to the terminal block. The first terminal includes a first thermal bonding bonded to the lead wire by thermal caulking or welding, and a first mechanical coupling mechanically coupled to the lead wire at a position closer to the stator coil than the first thermal bonding.

### CROSS REFERENCE TO RELATED APPLICATION

The present application is a continuation application of International Patent Application No. PCT/JP2022/031098 filed on Aug. 17, 2022, which designated the U.S. and claims the benefit of priority from Japanese Patent Application No. 2022-018173 filed on Feb. 8, 2022. The entire disclosures of all of the above applications are incorporated herein by reference.

### TECHNICAL FIELD

The present disclosure relates to a stator for a rotary electric machine.

### BACKGROUND

Conventionally, a stator is known including a connection terminal, which is connected to a lead wire of a stator coil.

### SUMMARY

According to an aspect of the present disclosure, a stator is applicable to a rotary electric machine including a terminal block.

### BRIEF DESCRIPTION OF THE DRAWINGS

The foregoing and other objects, features, and advantages of the present disclosure will become more apparent from the following detailed description with reference to the accompanying drawings. The drawings are as follows:

FIG. 1 is a cross-sectional view of a rotary electric machine;

FIG. 2 is a wiring diagram of a stator coil;

FIG. 3 is a perspective view of a stator;

FIG. 4 is a side view of the stator;

FIG. 5 is a perspective view of a lead wire, a connection terminal, a bus bar, and a fastening terminal;

FIG. 6 is another perspective view of the lead wire, the connection terminal, the bus bar, and the fastening terminal;

FIG. 7 is an enlarged perspective view of the lead wire, the connection terminal, and the bus bar; and

FIG. 8 is a sectional view of the rotary electric machine in a modified example.

### DETAILED DESCRIPTION

Hereinafter, examples of the present disclosure will be described.

According to an example of the present disclosure, a stator includes a connection terminal, which is caulked to one end of a power line (i.e., a bus bar), and is welded to a lead wire drawn out from a stator coil (i.e., a stator coil) of a rotary electric machine.

When vibration occurs, a vibration load is applied to a welded part between the lead wire and the connection terminal. In parts that are bonded by applying heat, such as by welding or thermal caulking, the heat causes recrystallization of the metal structure, resulting in a reduction in strength. Therefore, the rotary electric machine may have reduced vibration resistance.

According to a first example,
a stator applicable to a rotary electric machine including a terminal block. The stator comprises:
a stator coil;
a lead wire drawn out from the stator coil;
a bus bar;
a first terminal electrically connecting the lead wire with the bus bar; and
a second terminal electrically connected to the bus bar and to be fixed to the terminal block.

The first terminal includes a first thermal bonding bonded to the lead wire by thermal caulking or welding, and a first mechanical coupling mechanically coupled to the lead wire at a position closer to the stator coil than the first thermal bonding.

According to the configuration described above, the stator is applicable to a rotary electric machine including a terminal block. The stator includes a stator coil. The lead wire drawn out from the stator coil and the bus bar are electrically connected by the first terminal. The second terminal is electrically connected to the bus bar, and fixed to the terminal block. Therefore, the terminal block and the stator coil can be electrically connected via the second terminal, the bus bar, the first terminal, and the lead wire.

Herein, the first terminal includes the first thermal bonding bonded to the lead wire by thermal caulking or welding. Therefore, although the lead wire and the first thermal bonding are firmly bonded, there is a risk that the strength is reduced due to recrystallization by the heat during bonding. In such regard, the first terminal includes the first mechanical coupling that is mechanically coupled to the lead wire on a stator coil side with respect to the first thermal bonding. Therefore, when vibration occurs in the stator, the vibration load can be borne by the first mechanical coupling. Further, since the first mechanical coupling is mechanically coupled to the lead wire, the strength is not reduced by heat during coupling. Therefore, the vibration resistance of the stator is improvable.

Generally, the lead wire has a structure in which a conductor is covered with an insulating film. When a terminal is bonded to a lead wire by heat caulking or welding, the insulating film of the lead wire is peeled off and the conductor is exposed. When the insulating film is peeled off from the lead wire, a part of the conductor is also scraped off. Therefore, in the lead wire, the strength of the part where the insulating film is peeled off is lower than the strength of a part covered with the insulating film.

In a second example, the lead wire includes a covered part in which a conductor is covered with an insulating film, and an exposed part in which the conductor is exposed. The first thermal bonding is bonded to the exposed part, and the first mechanical coupling is coupled to the covered part. Therefore, the first mechanical coupling is coupled to the covered part having higher strength than the exposed part, thus the vibration resistance of the stator is further improvable.

In a third example, the second terminal includes a second thermal bonding bonded to the bus bar by thermal caulking or welding, and a second mechanical coupling mechanically coupled to the bus bar at a position closer to the first terminal than the second thermal bonding. Therefore, when vibration occurs in the stator, the vibration load can be borne by the second mechanical coupling. Further, since the second mechanical coupling is mechanically coupled to the bus bar, the strength is not reduced by heat during coupling. Therefore, the vibration resistance of the stator is improvable. That is, the effects similar to the first example are achievable also at the connection part between the bus bar and the second terminal.

In a fourth example, the first terminal is formed in a plate shape and has a first surface and a second surface, which is opposite to the first surface. On the first surface, the first thermal bonding is bonded to the lead wire. On the first surface, the first mechanical coupling is coupled to the lead wire. The bus bar is fixed to the second surface. Therefore, interference between the lead wire and the bus bar is suppressible compared to the case where the lead wire and the bus bar are arranged on the same surface of the plate-shaped first terminal. Therefore, there is no need to make the first terminal extra-large, and the first terminal can be made smaller and lighter.

In a stator according to an example of the present disclosure, a lead wire extends from the stator coil in a direction away from the second terminal (i.e., the terminal block), and a bus bar extends from the connection part with the connection terminal (i.e., the first terminal) in a direction toward the second terminal. That is, the lead wire and the bus bar extend in a direction away from the second terminal, and then are folded back in a direction toward the second terminal. Therefore, the weight of the lead wire and the bus bar may increase, and the vibration resistance of such part may be reduced.

In such regard, in a fifth example, the lead wire extends from the stator coil in a direction toward the second terminal, and the bus bar extends from a connection part with the first terminal in a direction toward the second terminal. Therefore, the lead wire and the bus bar both extend in the direction toward the second terminal (i.e., the terminal block), and are not folded back in the direction toward the second terminal after extending in the direction away from the second terminal. Therefore, an increase in the weight of the lead wire and the bus bar is suppressible, and a reduction in vibration resistance is also suppressible.

An embodiment embodied as a stator of a rotary electric machine mounted on an electric vehicle or the like will be described below with reference to the drawings.

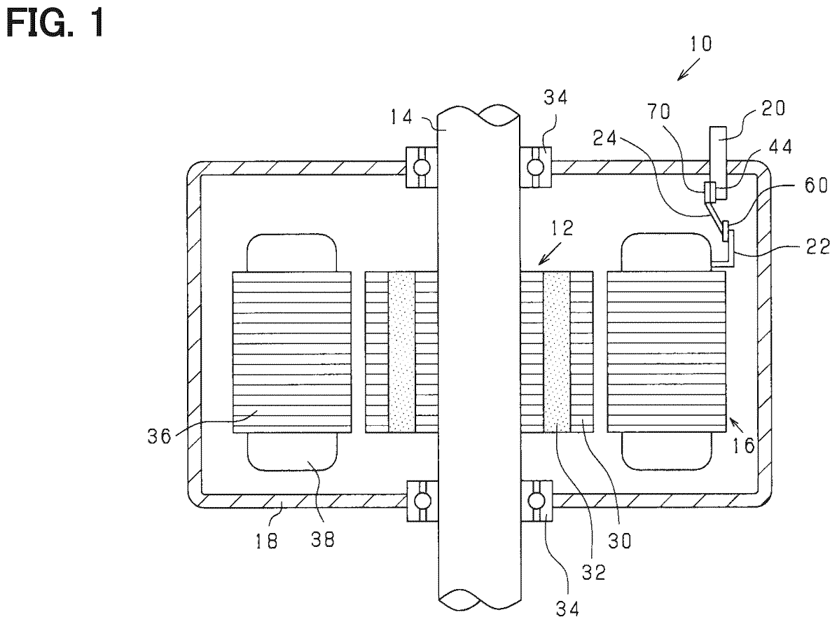

As shown in FIG. 1, a rotary electric machine 10 functions as an electric motor that receives electric power and generates rotational power, and also functions as a generator that receives rotational power and generates electric power. Note that the rotary electric machine 10 may function as only one of an electric motor and a generator.

The rotary electric machine 10 includes a rotor 12, a stator 16, a rotating shaft 14, and a housing 18. The rotor 12 includes a rotor core 30 and permanent magnets 32 embedded in the rotor core 30. The rotor core 30 is a columnar member formed by laminating electromagnetic steel plates (for example, silicon steel plates). The rotating shaft 14 is inserted through the center of the rotor core 30 and fixed thereto. The rotating shaft 14 is attached to the housing 18 via a bearing 34. The rotating shaft 14 and the rotor core 30 fixed to the rotating shaft 14 are rotatable with respect to the housing 18.

The stator 16 includes a stator core 36 and a stator coil 38. The stator core 36 is a substantially cylindrical member arranged concentrically with the rotor 12, and includes an annular yoke and a plurality of teeth protruding in a radial direction from an inner peripheral surface of the yoke. The plurality of teeth are arranged at predetermined intervals in a circumferential direction, and a slot, which is a space into which the stator coil 38 is inserted, is formed between two adjacent teeth. The stator core 36 is composed of a plurality of electromagnetic steel plates (for example, silicon steel plates) laminated in an axial direction. The plurality of electromagnetic steel plates are positioned and bonded to each other to constitute the stator core 36.

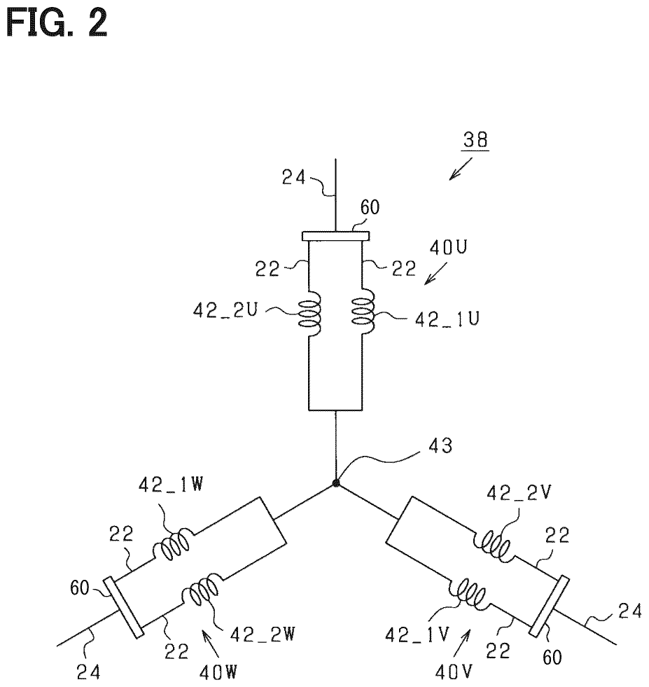

The stator coil 38 is configured by winding a winding wire around the teeth in a concentrated winding manner. FIG. 2 is a wiring diagram of the stator coil 38. The stator coil 38 includes three-phase coils, that is, a U-phase coil 40U, a V-phase coil 40V, and a W-phase coil 40W. In the following description, when the U-phase, V-phase, and W-phase are not distinguished, the letters U, V, and W will be omitted and they will be referred to as “phase coils 40.”

Each phase coil 40 is configured by connecting two phase coil parts in parallel. For example, the U-phase coil 40U is formed by connecting a U-phase first coil part 42_1U and a U-phase second coil part 42_2U in parallel. Similarly, the V-phase coil 40V is formed by connecting a V-phase first coil part 42_1V and a V-phase second coil part 42_2V in parallel, and the W-phase coil 40W is formed by connecting a W-phase first coil part 42_1W and a W-phase second phase coil part 42_2W in parallel. In the following description, the phase coil parts will also be referred to as “phase coil parts 42” by omitting the alphabets U, V, and W when the U-phase, V-phase, and W-phase are not distinguished.

Terminating ends of the two phase coil parts 42 of the same phase (for example, terminating ends of the two phase coil parts 42_1U and 42_2U belonging to the U phase) are bonded to each other. Further, starting ends of the two phase coil parts 42 of the same phase (for example, starting ends of the two phase coil parts 42_1U and 42_2U belonging to the U phase) are also bonded to each other. Note that, as described later, the starting end of each phase coil part 42 functions as a lead wire 22 drawn out from the stator coil 38.

Further, two lead wires 22 belonging to the same phase are connected in parallel by being bonded to a connection terminal 60, which will be described later. The terminating ends of the three phase coils 40 are bonded to each other to form a neutral point 43. Further, the starting ends of the three phase coils 40 are electrically connected to terminals 44 of a terminal block 20 via bus bars 24, and the like, which will be described later.

Note that a connection mode described here is just an example, and may be changed as appropriate. For example, in the example described above, the plurality of phase coil parts 42 are connected in parallel. However, they may be connected in series. Further, the number of phase coil parts 42 constituting one phase coil 40 may be three or more. Further, the winding wire is not limited to concentrated winding, but may be wound in other winding manners, for example, distributed winding.

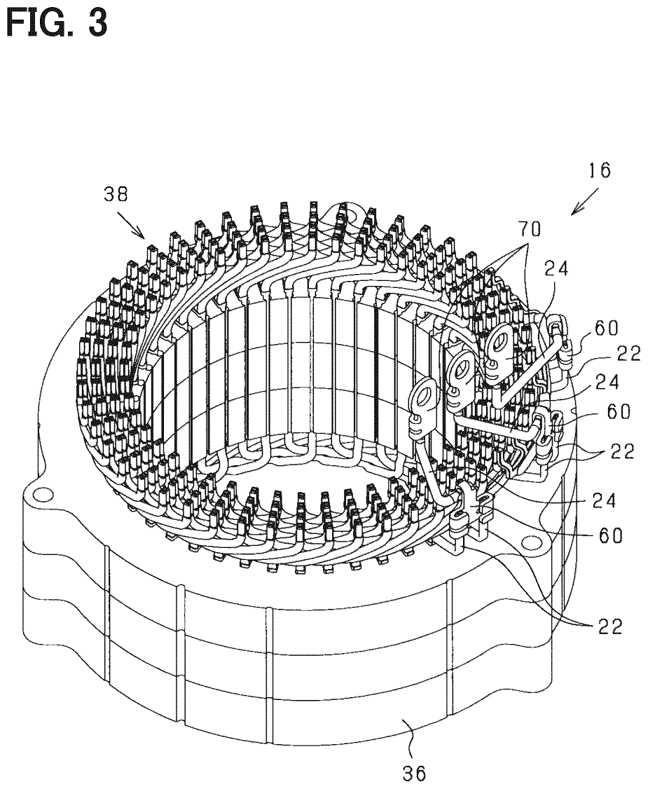

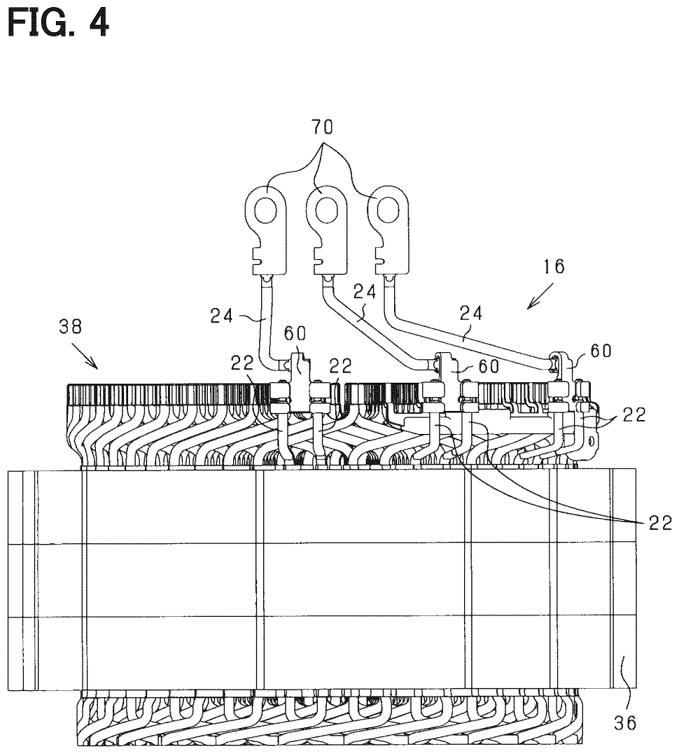

As shown in FIGS. 1, 3 and 4, a part of the stator coil 38 protrudes from an axial end surface of the stator core 36 to form a coil end part. From such coil end part, the lead wire 22, which is a starting end of the phase coil part 42, is drawn out to an outside in the axial direction of the stator 16 (i.e., the rotating shaft 14). As shown in FIG. 2, since there are six phase coil parts 42, there are also six lead wires 22. Each lead wire 22 is connected to the bus bar 24 via the connection terminal 60, which will be described later.

The bus bar 24 is a conducting wire that relays the lead wire 22 and the terminal block 20, and is capable of passing a large amount of electric current. The bus bar 24 is made of copper or the like, and is shaped like a rod or a plate. The connection terminal 60 and fastening terminal 70 are attached to both ends of the bus bar 24, and these will be described later.

The rotary electric machine 10 further includes the terminal block 20. The terminal block 20 is provided to penetrate the housing 18, i.e., both ends on an inside and an outside thereof. The terminal 44 to be fastened to the fastening terminal 70 is provided on a part of the terminal block 20 that protrudes into the housing 18. An external terminal (not shown) electrically connected to the terminal 44 is provided on a part of the terminal block 20 that protrudes to an outside of the housing 18. A conducting wire drawn out from an inverter or the like is connected to the external terminal.

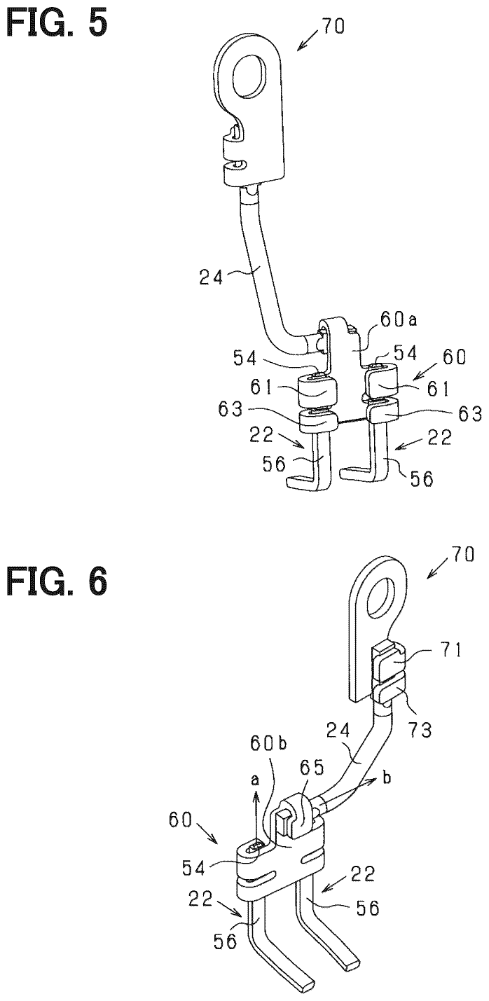

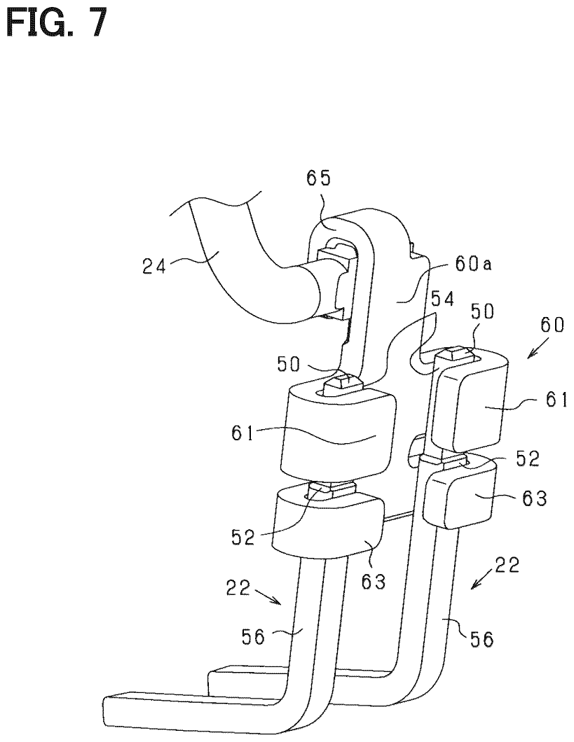

Next, a connection structure of the lead wire 22, the connection terminal 60, the bus bar 24, and the fastening terminal 70 will be described with reference to FIGS. 5 to 7.

As described, the lead wire 22 is a starting end of the phase coil part 42, and there are two lead wires 22 belonging to the same phase. The winding wire that constitutes the phase coil part 42 includes a coil conducting wire 50 and an insulating film 52 that covers the coil conducting wire 50. In the illustrated example, the coil conducting wire 50 (conductor) is a rectangular wire with a substantially rectangular cross section, but the form of the coil conducting wire 50 is not limited to the above, and may be a round wire with a circular cross section.

The lead wire 22 is drawn out from the coil end part to an outside of the stator core 36 in the axial direction. At an end part of the lead wire 22, the insulating film 52 is peeled off, and the coil conducting wire 50 is exposed to the outside. That is, the lead wire 22 has a covered part 56 where the coil conducting wire 50 is covered with the insulating film 52, and a peeled part 54 (i.e., an exposed part) where the coil conducting wire 50 is exposed to the outside without being covered by the insulating film 52. The coil conducting wire 50 is slightly shaved off when the insulating film 52 is peeled off, and the coil conducting wire 50 in the peeled part 54 is slightly thinner than the coil conducting wire 50 in the covered part 56. Therefore, the strength of the peeled part 54 is lower than the strength of the covered part 56.

The connection terminal 60 (i.e., a first terminal) is formed in a plate shape of copper alloy or the like. The connection terminal 60 has a first surface 60a as a main surface having the largest area and a second surface 60b opposite to the first surface 60a. Two lead wires 22 belonging to the same phase are connected to the connection terminal 60. Thereby, the two lead wires 22 and, ultimately, the phase coil part 42 are connected in parallel.

The connection terminal 60 includes a first thermal bonding 61 bonded to the lead wire 22 by welding. The first thermal bonding 61 is bent toward a first surface 60a side, and sandwiches the peeled part 54 of the lead wire 22. That is, the first thermal bonding 61 is crimped to the peeled part 54 of the lead wire 22. Further, on the first surface 60a, the first thermal bonding 61 is bonded to the peeled part 54 of the lead wire 22 by welding.

The connection terminal 60 includes a first mechanical coupling 63 that is caulked (mechanically coupled) to the lead wire 22 on one end closer to the stator coil 38 than the first thermal bonding 61. The first mechanical coupling 63 is provided in parallel with (i.e., is in parallel connection with) the first thermal bonding 61. The first mechanical coupling 63 is bent toward the first surface 60a side, and sandwiches the covered part 56 of the lead wire 22. That is, the first mechanical coupling 63 is crimped (i.e., fixed) to the covered part 56 of the lead wire 22 on the first surface 60a. When the first mechanical coupling 63 is crimped onto the covered part 56 of the lead wire 22, the first mechanical coupling 63 is not heated.

The bus bar 24 is a conducting wire having a substantially circular cross section. This bus bar 24 is not covered with an insulating film. Further, the bus bar 24 has one end connected to the connection terminal 60, and has other end connected to the fastening terminal 70 (i.e., electrically connected).

The connection terminal 60 includes a third mechanical coupling 65 that is crimped (i.e., mechanically coupled) to the bus bar 24. The third mechanical coupling 65 is bent toward a second surface 60b side, and sandwiches the bus bar 24. That is, the third mechanical coupling 65 is crimped (i.e., coupled, fixed) to the bus bar 24 on the second surface 60b. Note that, on the second surface 60b, the third mechanical coupling 65 may be bonded (i.e., fixed) to the bus bar 24 by welding. Further, a protrusion direction b of the bus bar 24 from the third mechanical coupling 65 and a protrusion direction a of the lead wire 22 sandwiched by the first thermal bonding 61 and the first mechanical coupling 63 are set to be different from each other, thereby preventing rotation and coming off of the bus bar 24 due to vibration, and realizing a structure that is more resistant to vibration.

The fastening terminal 70 (i.e., the second terminal) is formed in a plate shape of copper alloy or the like. The fastening terminal 70 includes a second thermal bonding 71 bonded to the lead wire 22 by welding. The second thermal bonding 71 is bent toward a bus bar 24 side, and sandwiches the bus bar 24. That is, the second thermal bonding 71 is crimped to the bus bar 24. The second thermal bonding 71 is bonded to the bus bar 24 by welding.

The fastening terminal 70 includes a second mechanical coupling 73 that is caulked (mechanically coupled) to the bus bar 24 on the side closer to the connection terminal 60 than the second thermal bonding 71. The second mechanical coupling 73 is provided in parallel with (i.e., to have a parallel connection to) the second thermal bonding 71. The second mechanical coupling 73 is bent toward the bus bar 24 side, and sandwiches the bus bar 24. That is, the second mechanical coupling 73 is crimped (i.e., fixed) to the bus bar 24. When the second mechanical coupling 73 is crimped onto the bus bar 24, the second mechanical coupling 73 is not heated.

The fastening terminal 70 has, formed thereon, a fastening hole 70a through which a bolt or the like is passed. The fastening terminal 70 is placed on the terminal 44 provided on the terminal block 20, and is fastened (i.e., fixed) by a bolt or the like passed through the fastening hole 70a.

By the way, in the stator described in Patent Document 1, a lead wire extends from the stator coil in a direction away from the fastening terminal (i.e., the terminal block), and a bus bar extends from the connection part with the connection terminal in a direction toward the fastening terminal. That is, the lead wire and the bus bar extend in a direction away from the fastening terminal, and then are folded back in a direction toward the fastening terminal. Therefore, the weight of the lead wire and the bus bar may increase, and the vibration resistance of such part may be reduced. Note that the vibration load is generated as the electric vehicle or the like travels or as the rotary electric machine 10 rotates, and the heavier the member, the greater the vibration load.

In this respect, the lead wire 22 and the bus bar 24 extend from the stator coil 38 in a direction toward the fastening terminal 70 (i.e., the terminal block 20). Specifically, the lead wire 22 extends from the stator coil 38 in a direction toward the fastening terminal 70. The bus bar 24 extends from the connection part of the connection terminal 60 in a direction toward the fastening terminal 70.

The present embodiment described above in detail has the following advantages.
The connection terminal 60 includes the first thermal bonding 61 bonded to the lead wire 22 by welding. Therefore, although the lead wire 22 and the first thermal bonding 61 are firmly bonded, there is a possibility that the strength of the bonding may be reduced due to recrystallization by the heat during bonding. In particular, copper tends to have bigger crystal by heating, and its strength tends to be reduced. In such regard, the connection terminal 60 includes the first mechanical coupling 63 that is mechanically coupled to the lead wire 22 on the side closer to the stator coil 38 than the first thermal bonding 61. Therefore, when vibration occurs in the stator 16, the vibration load acting on the lead wire 22 and the connection terminal 60 is borne by the first mechanical coupling 63. Further, since the first mechanical coupling 63 is mechanically coupled to the lead wire 22, the strength is not reduced by the heat during coupling. Therefore, the vibration resistance of the stator 16 is improvable.
The lead wire 22 includes the covered part 56 in which the coil conducting wire 50 is covered with the insulating film 52, and the peeled part 54 in which the coil conducting wire 50 is exposed. The first thermal bonding 61 is bonded to the peeled part 54, and the first mechanical coupling 63 is coupled to the covered part 56. Therefore, the first mechanical coupling 63 is coupled to the covered part 56 which has higher strength than the peeled part 54, and the vibration resistance of the stator 16 is further improvable.
The fastening terminal 70 includes the second thermal bonding 71 bonded to the bus bar 24 by welding, and the second mechanical coupling 73 mechanically coupled to the bus bar 24 on the connection terminal 60 side of the second thermal bonding 71. Therefore, when vibration occurs in the stator 16, the vibration load acting on the bus bar 24 and the fastening terminal 70 is borne by the second mechanical coupling 73. Further, since the second mechanical coupling 73 is mechanically coupled to the bus bar 24, the strength of the coupling is not reduced by the heat during coupling. Therefore, the vibration resistance of the stator 16 is improvable.
The connection terminal 60 is formed in a plate shape, and includes the first surface 60a and the second surface 60b opposite to the first surface 60a, and the first thermal bonding 61 is bonded to the lead wire 22 on the first surface 60a, and the first mechanical coupling 63 is coupled to the lead wire 22 on the first surface 60a, and the bus bar 24 is fixed to the second surface 60b. According to such configuration, the lead wire 22 is arranged on the first surface 60a of the connection terminal 60, and the bus bar 24 is arranged on the second surface 60b opposite to the first surface 60a. Therefore, interference between the lead wire 22 and the bus bar 24 is suppressible compared to the case where the lead wire 22 and the bus bar 24 are arranged on the same surface of the plate-shaped connection terminal 60. Therefore, there is no need to make the connection terminal 60 extra large, and the connection terminal 60 can be made smaller and lighter.
The lead wire 22 extends from the stator coil 38 in a direction toward the fastening terminal 70, and the bus bar 24 extends from the connection part of the connection terminal 60 in a direction toward the fastening terminal 70. Therefore, the lead wire 22 and the bus bar 24 both extend in the direction toward the fastening terminal 70 (i.e., the terminal block 20), and are not folded back in the direction toward the fastening terminal 70 after extending in the direction away from the fastening terminal 70. Therefore, it is possible to suppress an increase in the weight of the lead wire 22 and the bus bar 24, and it is possible to suppress a reduction in vibration resistance.

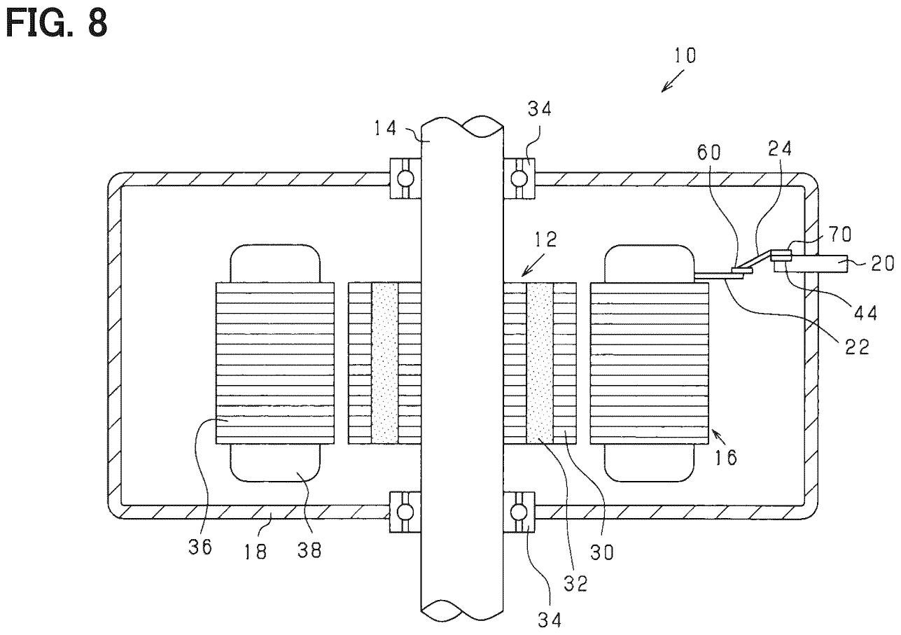

The embodiment described above may be modified in the following manners. Parts identical to the parts of the above embodiment are designated by the same reference signs as the above embodiment to omit redundant description.
As shown in FIG. 8, it is also possible to employ a configuration in which the lead wire 22 is drawn out from the coil end part to the outside in the radial direction of the stator core 36. Even in such case, the lead wire 22 extends from the stator coil 38 in a direction toward the fastening terminal 70, and the bus bar 24 extends from the connection part of the connection terminal 60 in a direction toward the fastening terminal 70. Therefore, it is possible to suppress an increase in the weight of the lead wire 22 and the bus bar 24, and it is possible to suppress a reduction in vibration resistance.
It is also possible to employ a configuration in which the lead wire 22 and the bus bar 24 extend in a direction away from the fastening terminal 70 and then are folded back in a direction toward the fastening terminal 70.
It is also possible to employ a configuration in which the connection terminal 60 has the first thermal bonding 61 bonded to the lead wire 22 on the first surface 60a, and has the first mechanical coupling 63 coupled to the lead wire 22, and the bus bar 24 is fixed to the first surface 60a. Similarly, a configuration in which the first thermal bonding 61, the first mechanical coupling 63, and the bus bar 24 are fixed to the second surface 60b can also be adopted.
The connection terminal 60 may be formed in a rod shape, and may include the first thermal bonding 61, the first mechanical coupling 63, and the third mechanical coupling 65 as a branch part.
The first mechanical coupling 63 of the connection terminal 60 may be crimped (i.e., mechanically coupled) to the peeled part 54.
The connection terminal 60 may include the first thermal bonding 61 bonded to the lead wire 22 by thermal caulking. In such case as well, there is a risk that the strength of the lead wire 22 and the connection terminal 60 will be reduced by the heat during bonding, but the vibration load acting on the lead wire 22 and the connection terminal 60 can be borne by the first mechanical coupling 63.
The fastening terminal 70 may include the second thermal bonding 71 bonded to the bus bar 24 by thermal caulking. Even in such case as well, although there is a risk that the strength of the bus bar 24 and the fastening terminal 70 may be reduced by the heat generated during joining, the vibration load acting on the bus bar 24 and the fastening terminal 70 can be borne by the second mechanical coupling 73.
The fastening terminal 70 may include a mechanical coupling similar to the second mechanical coupling 73 instead of the second thermal bonding 71. Further, one of the second thermal bonding 71 and the second mechanical coupling 73 may be omitted.
The rotary electric machine 10 is not limited to an inner rotor structure, but may have an outer rotor structure.

Although the present disclosure has been made in accordance with the embodiment, it is understood that the present disclosure is not limited to such embodiment and structure. The present disclosure incorporates various modifications and variations within the scope of equivalents. In addition, other combinations and configurations, additionally including one element, more than one, less than one, are also within the spirit and scope of the present disclosure.

Characteristic configurations extracted from the above-described embodiment and the modified example will be described below.

### [Configuration 1]

A stator (16) applicable to a rotary electric machine (10) that includes a terminal block (20) and includes a stator coil (38), includes:
a lead wire (22) drawn out from the stator coil;
bus bar (24);
a first terminal (60) that electrically connects the lead wire with the bus bar; and
a second terminal (70) electrically connected to the bus bar and fixed to the terminal block, wherein
the first terminal includes
a first thermal bonding (61) bonded to the lead wire by thermal caulking or welding, and
a first mechanical coupling (63) mechanically coupled to the lead wire at a position closer to the stator coil than the first thermal bonding.

### [Configuration 2]

The stator of a rotary electric machine according to configuration 1, wherein
the lead wire includes
a covered part (56) in which a conductor (50) is covered with an insulating film (52), and
an exposed part (54) in which the conductor is exposed,
the first thermal bonding is bonded to the exposed part, and
the first mechanical coupling is coupled to the covered part.

### [Configuration 3]

The stator of a rotary electric machine according to configuration 1 or 2, wherein
the second terminal includes
a second thermal bonding (71) bonded to the bus bar by thermal caulking or welding, and
a second mechanical coupling (73) mechanically coupled to the bus bar at a position closer to the first terminal than the second thermal bonding.

### [Configuration 4]

The stator of a rotary electric machine according to any one of configurations 1 to 3, wherein
the first terminal is formed in a plate shape, and includes a first surface (60a) and a second surface (60b) opposite to the first surface,
on the first surface, the first thermal bonding is bonded to the lead wire,
on the first surface, the first mechanical coupling is coupled to the lead wire, and
the bus bar is fixed to the second surface.

### [Configuration 5]

The stator of a rotary electric machine according to any one of configurations 1 to 4, wherein
the lead wire extends from the stator coil in a direction toward the second terminal, and
the bus bar extends from a connection part with the first terminal in a direction toward the second terminal.

What is claimed is:

1. A stator applicable to a rotary electric machine including a terminal block, the stator comprising:
a stator coil;
a lead wire drawn out from the stator coil;
a bus bar;
a first terminal electrically connecting the lead wire with the bus bar; and
a second terminal electrically connected to the bus bar and to be fixed to the terminal block, wherein
the first terminal includes
a first thermal bonding bonded to the lead wire by thermal caulking or welding, and
a first mechanical coupling mechanically coupled to the lead wire at a position closer to the stator coil than the first thermal bonding.

2. The stator for the rotary electric machine according to claim 1, wherein
the lead wire includes
a covered part in which a conductor is covered with an insulating film, and
an exposed part in which the conductor is exposed,
the first thermal bonding is bonded to the exposed part, and
the first mechanical coupling is coupled to the covered part.

3. The stator for the rotary electric machine according to claim 1, wherein
the second terminal includes
a second thermal bonding bonded to the bus bar by thermal caulking or welding, and
a second mechanical coupling mechanically coupled to the bus bar at a position closer to the first terminal than the second thermal bonding.

4. The stator for the rotary electric machine according to claim 1, wherein
the first terminal is formed in a plate shape and has a first surface and a second surface, which is opposite to the first surface,
on the first surface, the first thermal bonding is bonded to the lead wire,
on the first surface, the first mechanical coupling is coupled to the lead wire, and
the bus bar is fixed to the second surface.

5. The stator for the rotary electric machine according to claim 1, wherein
the lead wire extends from the stator coil in a direction toward the second terminal, and
the bus bar extends from a connection part with the first terminal in a direction toward the second terminal.
